(19) United States
(12) Patent Application Publication
(10) Pub. No.: US 2004/0187033 A1
(43) Pub. Date: Sep. 23, 2004

(54) Gateway for use in a network monitoring system to control packet flow to a firewall

(75) Inventor: Kuo-Chung Wang, Taipei City (TW)

Correspondence Address: OSTROLENK FABER GERB & SOFFEN, 1180 AVENUE OF THE AMERICAS, NEW YORK, NY, 100368403

(73) Assignee: eTrunk Technologies Inc.

(21) Appl. No.: 10/639,205

(22) Filed: Aug. 11, 2003

(30) Foreign Application Priority Data
Mar. 19, 2003 (TW) 092106098

(51) Int. Cl. G06F 11/30; G06F 15/173

(52) U.S. Cl. 713/201; 709/223

(57) ABSTRACT

A gateway for a network monitoring system includes connection ports connected respectively to external and internal networks and to external and internal connection ports of a firewall. A processing unit of the gateway includes filter modules for determining whether incoming and outgoing data packets comply with rules stored in a data storage device, and bridging modules for controlling packet flow among the external and internal networks and the firewall according to data packet conditions determined by the filter modules.

### CROSS-REFERENCE TO RELATED APPLICATION

This application claims priority of Taiwanese application no. 092106098, filed on Mar. 19, 2003.

### BACKGROUND OF THE INVENTION

1. Field of the Invention

The invention relates to a network monitoring system, more particularly to a gateway for use in a network monitoring system to control packet flow to a firewall.

2. Description of the Related Art

As shown in FIG. 1, a firewall 93 is usually provided between an internal network 91 and an external network 92, such as the Internet. The firewall 93 primarily serves to protect the internal network 91 from damaging attacks or intrusions initiated by hackers through the external network 92. The firewall 93 can further serve to enhance security of the internal network 91 by blocking leakage of trade secrets through unauthorized e-mails by users of the internal network 91.

Apart from general filter firewalls and proxy firewalls, firewalls with Network Address Translation (NAT) capability are available to shield the physical Internet Protocol (IP) addresses of users of the internal network 91 from the external network 92 and to offer virtual IP addresses to compensate for inadequate physical IP addresses.

However, although the use of virtual IP addresses does offer value-added advantages, other problems arise. For example, when the user of the internal network 91 intends to use an Internet phone, a network conference, an on-line network game, or other real-time interactive multi-media network services, unless a physical IP address recognizable by the Internet 92 is in use, the aforesaid services will be unavailable. On the other hand, if any of the aforesaid services are made possible by bypassing the NAT firewall and by establishing a direct connection with the external network 92, network security cannot be guaranteed.

As an alternative, network administration personnel can follow the advice of Internet phone vendors and accordingly reserve a portion of available connection ports of the firewall 93 for the servicing of specific data packets, such as those associated with the Internet phone service, to resolve the aforesaid problem. However, the acts of configuring and managing the reserved connection ports will result in extra burden to network administration personnel, and may be technically infeasible to a small enterprise or an ordinary user who lacks the requisite technical skills.

### SUMMARY OF THE INVENTION

Therefore, the main object of the present invention is to provide a gateway for use in a network monitoring system to control packet flow to a firewall so as to overcome the aforesaid drawbacks associated with the prior art.

Another object of the present invention is to provide a network monitoring system adapted to be connected to external and internal networks and capable of overcoming the aforesaid drawbacks associated with the prior art.

According to one aspect of the present invention, there is provided a gateway for use in a network monitoring system that includes a firewall having internal and external connection ports. The gateway is adapted to be connected to external and internal networks, is adapted to control packet flow to the firewall, and comprises a first connection port adapted to be connected to the external network, a second connection port adapted to be connected to the internal network, a third connection port adapted to be connected to the external connection port of the firewall, a fourth connection port adapted to be connected to the internal connection port of the firewall, a data storage device, and a processing unit. The data storage device stores a rules database therein. The rules database includes rules associated with incoming data packets transmitted from the external network and to be directed to the internal network, and rules associated with outgoing data packets transmitted from the internal network and to be directed to the external network. The processing unit is coupled to the first, second, third and fourth connection ports and the data storage device. The processing unit includes filter modules for determining whether incoming and outgoing data packets comply with the rules in the rules database, and bridging modules for bridging the incoming and outgoing data packets among the internal network, the external network and the firewall according to data packet conditions determined by the filter modules, thereby controlling packet flow among the external and internal networks and the firewall.

According to another aspect of the present invention, a network monitoring system is adapted to be connected to external and internal networks and comprises a firewall having internal and external connection ports, and a gateway for controlling packet flow to the firewall. The gateway includes a first connection port adapted to be connected to the external network, a second connection port adapted to be connected to the internal network, a third connection port adapted to be connected to the external connection port of the firewall, a fourth connection port adapted to be connected to the internal connection port of the firewall, a data storage device, and a processing unit. The data storage device stores a rules database therein. The rules database includes rules associated with incoming data packets transmitted from the external network and to be directed to the internal network, and rules associated with outgoing data packets transmitted from the internal network and to be directed to the external network. The processing unit is coupled to the first, second, third and fourth connection ports and the data storage device. The processing unit includes filter modules for determining whether incoming and outgoing data packets comply with the rules in the rules database, and bridging modules for bridging the incoming and outgoing data packets among the internal network, the external network and the firewall according to data packet conditions determined by the filter modules, thereby controlling packet flow among the external and internal networks and the firewall.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional network system with a firewall interposed between internal and external networks;

FIG. 2 is a schematic diagram of a network monitoring system that incorporates the preferred embodiment of a gateway according to the present invention for controlling packet flow to a firewall;

FIG. 3 is a schematic block diagram of the preferred embodiment of the gateway according to the present invention;

FIG. 4 is a schematic diagram illustrating a data packet associated with VoIP services; and

FIG. 5 is a flowchart to illustrate how outgoing data packets are processed by a processing unit of the gateway of the preferred embodiment.

### DETAILED DESCRIPTION OF THE PREFERRED EMBODIMENT

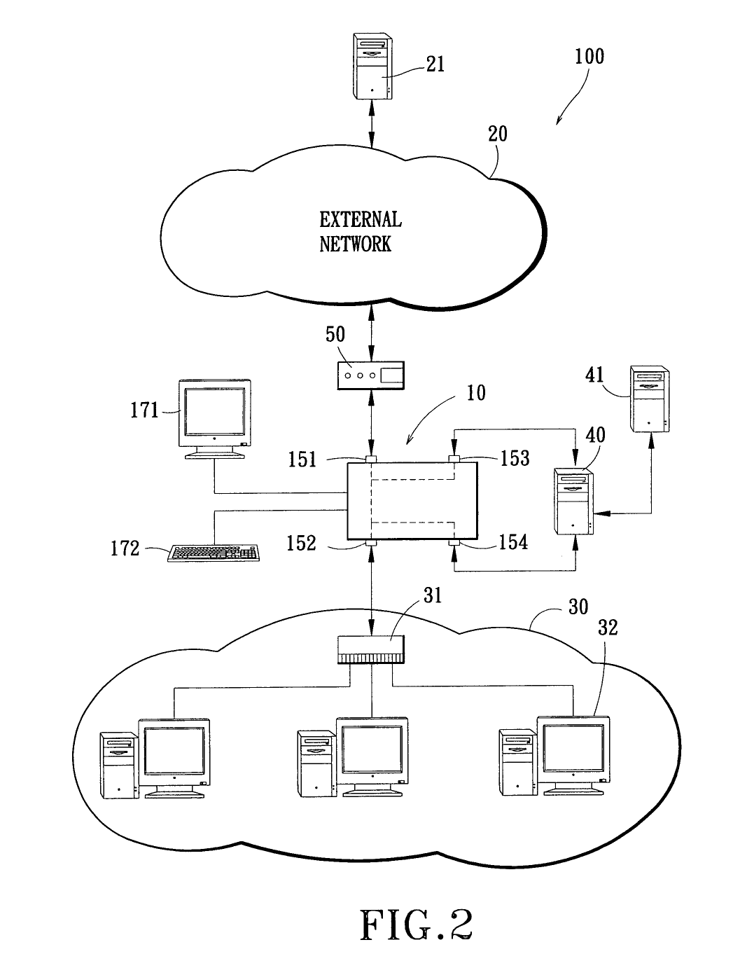

As shown in FIG. 2, the preferred embodiment of a gateway 10 according to the present invention is used in a network monitoring system of a network environment 100 to control packet flow to a firewall 40 of the network monitoring system. The network environment 100 includes an external network 20 and an internal network 30. The firewall 40 is interposed between the external and internal networks 20, 30. Due to the presence of the gateway 10 and the firewall 40, the network monitoring system permits a real-time interactive Voice On Internet Protocol (VoIP) service between the external network 20 and the internal network 30 while ensuring security of the internal network 30.

In this embodiment, the external and internal networks 20, 30 are respectively exemplified using the Internet and an enterprise intranet. However, those skilled in the art are aware that the external network 20 should not be restricted to a Wide Area Network (WAN). A Local Area Network (LAN), such as another enterprise intranet, can be used instead of the Internet.

Moreover, in the network environment 100 shown in FIG. 2, the gateway 10 is connected to the external network 20 by an ADSL modem 50. However, the connecting medium therebetween can be a dial-up modem, a wideband cable modem, an ISDN service network, a T1-leased line, or any other wired or wireless connection currently available from network service providers.

For illustrative purposes, personal computers 32 in the internal network 30 of the network environment 100 are connected to the gateway 10 through a conventional Ethernet Hub 31. However, it is feasible to replace the hub 31 with other mechanisms, such as a token ring network system. A network server internal to the enterprise may be interposed between the gateway 10 and the hub 31, and the network server may be connected to another or several other hubs 31. The personal computers 32 may be replaced with other electronic apparatus. In this embodiment, the firewall 40 is a conventional server with NAT capability, and is further connected to another conventional De-Militarized Zone (DMZ) server 41.

It is also worthwhile to note that the gateway 10 can be realized in the form of hardware (such as an expansion card for a personal computer), software, or combinations of both hardware and software.

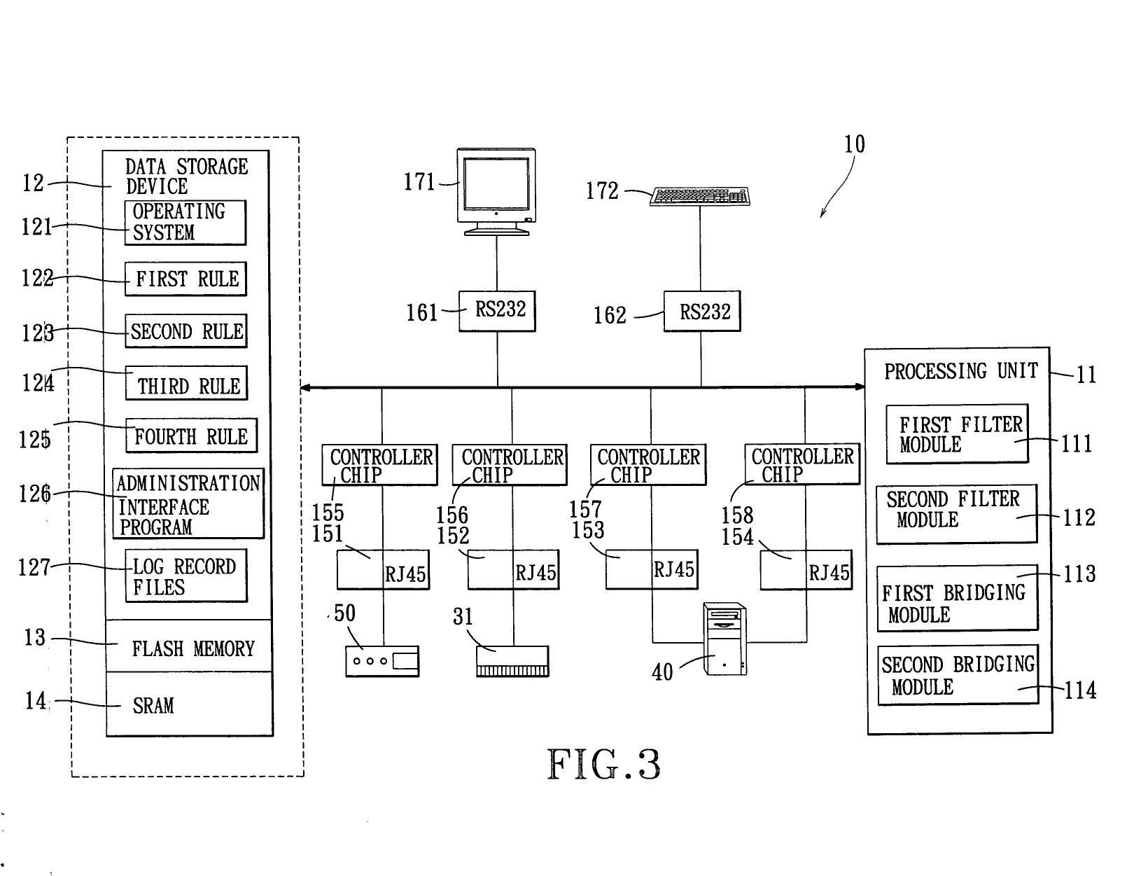

As shown in FIG. 3, the gateway 10 includes a processing unit 11, a data storage device 12, a flash memory 13, a static random access memory (SRAM) 14, a first connection port 151, a second connection port 152, a third connection port 153, a fourth connection port 154, a first terminal connection port 161, and a second terminal connection port 162. In this embodiment, the processing unit 11 is a central processing unit (CPU) (for example, an Intel 486 chip) or other suitable semiconductor chips. The data storage device 12 is embodied in a hard disk. However, a magnetic storage device, such as a floppy disk, a magnetic tape, etc., an optical storage device, such as a compact disc, etc., or other fixed or removable digital data storage devices can be used instead.

The data storage device 12 is used to store an Operating System 121 (such as a Linux Operating System), an administration interface program 126, a plurality of log record files 127, a rules database including a first rule 122, a second rule 123, a third rule 124 and a fourth rule 125, and other support programs (not shown herein).

In order to establish a physical VoIP connection between the external and internal networks 20, 30 without being undesirably affected by the firewall 40, the first and second rules 122, 123 must be related to the characteristics of a VoIP data packet. In this embodiment, the initiation procedure of the VoIP call session is activated through the Session Initiation Protocol (SIP) regulated by the Internet Engineering Task Force (IETF). Once mutual confirmation of the session has been established, VoIP data transmission can then proceed in accordance with the Transport Protocol for Real-Time Applications (RTP).

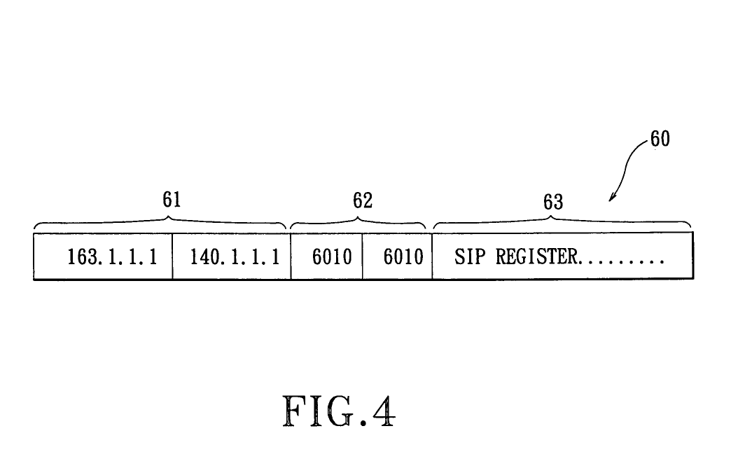

According to the SIP, before any personal computer 32 in the internal network 30 can establish a VoIP session with another party (not shown) through the external network 20, both parties have to register their respective IP and URL addresses to a registry sever 21 connected to the external network 20. As shown in FIG. 4, a typical user datagram protocol/Internet protocol (UDP/IP) data packet 60 that is used in the VoIP service and that is sent to the registry sever 21 includes an IP header segment 61, a UDP header segment 62, and a payload segment 63. The IP header segment 61 includes a source node address (for example, 163.1.1.1 in FIG. 4) and a target node address (for example, 140.1.1.1 in FIG. 4). The UDP header segment 62 includes a source connection port code (for example, 6010 in FIG. 4) and a target connection port code (for example, 6010 as shown in FIG. 4), which correspond to a specific application program. The payload segment 63 includes information relevant to the registry request (such as SIP register in FIG. 4). It should be noted herein that the IP address and UDP connection port code shown in FIG. 4 are only for illustrative purposes.

Referring again to FIGS. 3 and 4, in this embodiment, the contents of the first and second rules 122, 123 are chosen to correspond to the connection port code of the aforesaid UDP/IP data packet 60 used in the registry request. In other words, when the connection port codes of the UDP header segment 62 of the UDP/IP data packet 60 have the same value 6010, then each of the first and second rules 122, 123 indicates the code of the same connection port 6010 dedicated to VoIP services. Accordingly, whether or not a data packet is associated with the VoIP service can be determined based on the first and second rules 122, 123. It should be pointed out herein that the aforesaid first and second rules 122, 123 may also include a plurality of connection port codes, TCP (Transport Control Protocol) port codes, IP addresses or other data formats. Moreover, instead of the VoIP service, the first and second rules 122, 123 may be designed for other services, such as an on-line game, real-time image transmission, real-time interactive multi-media transmission, other real-time or non-real time data transmissions, etc. Furthermore, to prevent unauthorized users of the internal network 30 from utilizing the VoIP service to establish a connection with a node in the external network 20, in this embodiment, the third and fourth rules 124, 125 are set up based on the IP addresses of the personal computers 32 used by unauthorized users. Accordingly, when the IP address of a data packet indicates that of an unauthorized user, this implies that the data packet complies with the third or fourth rule 124, 125.

Referring again to FIGS. 2 and 3, the first, second, third and fourth connection ports 151, 152, 153, 154 are respectively connected to a corresponding port of the modem 50 for connecting with the external network 20, to a corresponding port of the hub 31 for connecting with the internal network 30, to a corresponding external connection port of the firewall 40, and to a corresponding internal connection port of the firewall 40. In this embodiment, the first, second, third and fourth connection ports 151, 152, 153, 154 are implemented using RJ45 connectors. Hardware controller chips 155, 156, 157, 158 corresponding respectively to the connection ports 151, 152, 153, 154 are mounted inside the gateway 10.

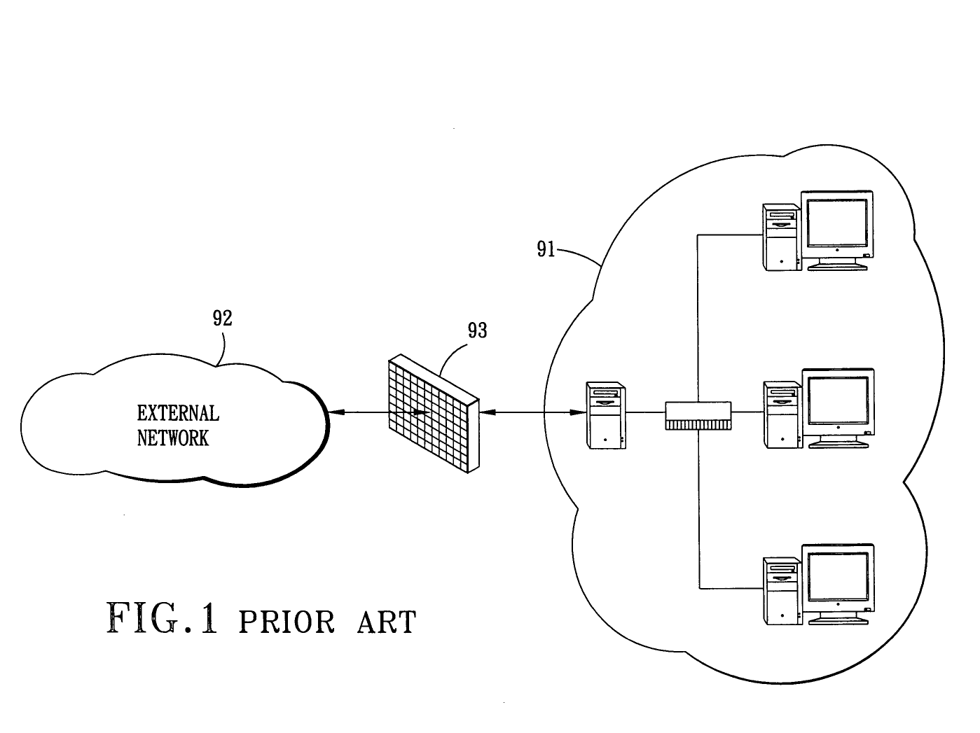

In this embodiment, the first and second terminal connection ports 161, 162 are implemented using RS232 connectors and are used for connecting the gateway 10 to a monitor 171 and an input device 172, such as a keyboard. Through the administration interface program 126 stored in the data storage device 12, the monitor 171 can be used to monitor the operating status of the gateway 10 and the flow of data packets passing through the gateway 10, and to view the log record files 127 stored in the data storage device 12. The input device 172 can be used for configurations and routine maintenance operations. Naturally, the gateway 10 also allows the user to perform management operations on a specific computer 32 (see FIG. 1) in the internal network 30 therethrough.

The processing unit 11 is coupled to the first, second, third and fourth connection ports 151, 152, 153, 154, the first and second terminal connection ports 161, 162, and the data storage device 12, and includes a first filter module 111, a second filter module 112, a first bridging module 113, and a second bridging module 114. The functions of the various modules of the processing unit 11 will be described in greater detail in the succeeding paragraphs.

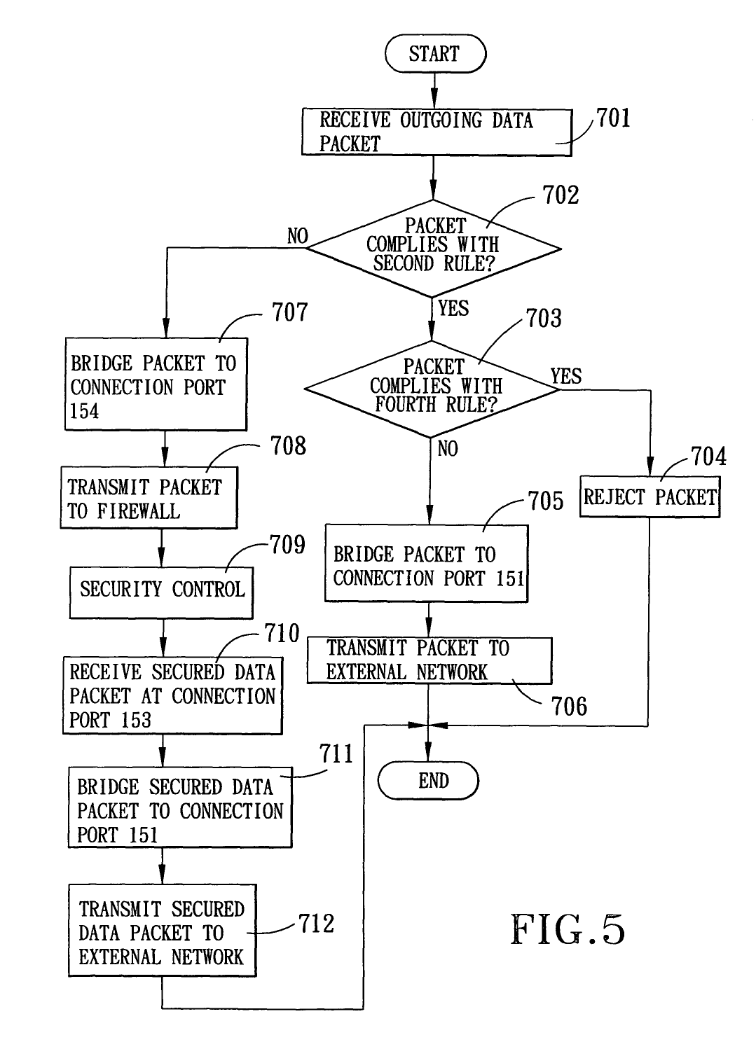

FIG. 5 is a flowchart to illustrate how outgoing data packets are processed by the processing unit 11. First, in step 701, an outgoing data packet transmitted by a personal computer 32 through the hub 31 of the internal network 30 is received at the second connection port 152. Then, in step 702, the second filter module 112 of the processing unit 11 determines whether the outgoing data packet complies with the second rule 123. In the negative, the flow goes to step 707. Otherwise, the flow goes to step 703.

In step 703, when the outgoing data packet complies with the second rule 123 (i.e., the outgoing data packet is an aforesaid VoIP packet), the second filter module 112 further determines whether the outgoing data packet complies with the fourth rule 125. In the negative, the flow goes to step 705. Otherwise, the flow goes to step 704.

In step 704, when the outgoing data packet complies with the fourth rule 125, indicating that the data packet was transmitted by an unauthorized user of the internal network 30, the second bridging module 114 rejects and blocks further flow of the outgoing data packet. At the same time, this event is logged in a log record file 127 for later reference by network administration personnel.

In step 705, when the outgoing data packet does not comply with the fourth rule 125, indicating that the data packet was transmitted by an authorized user of the internal network 30, the second bridging module 114 bridges the outgoing data packet to the first connection port 151. Thereafter, in step 706, the modem 50 will transmit the outgoing data packet to the registry server 21 that is connected to the external network 20. In this manner, a direct connection with the registry server 21 is established by bypassing the security control mechanism of the firewall 40.

In step 707, when the outgoing data packet does not comply with the second rule 123 (i.e., the outgoing data packet is not an aforesaid VoIP packet), the second bridging module 114 bridges the outgoing data packet to the fourth connection port 154. Thereafter, in step 708, the firewall 40 receives the outgoing data packet directly from the fourth connection port 154. Subsequently, in step 709, the firewall 40 performs security control, such as NAT, upon the outgoing data packet. Then, in step 710, the secured outgoing data packet will be provided by the firewall 40 to the third connection port 153. Thereafter, the secured outgoing data packet will be bridged to the first connection port 151. Subsequently, in step 712, the modem 50 transmits the secured outgoing data packet for reception by a target node in the external network 20.

In a similar manner, an incoming data packet received at the first connection port 151 from the external network 20 through the modem 50 will be processed by the first filter module 111 to determine whether the incoming data packet complies with the first rule 122. If the incoming data packet complies with the first rule 122 (that is, the incoming data packet is a VoIP packet), the first filter module 111 further determines whether the incoming data packet complies with the third rule 124. When the incoming data packet complies with both the first and third rules 122, 124, indicating that the VoIP data packet is directed to an unauthorized user of the internal network 30, the first bridging module 113 rejects and blocks further flow of the incoming data packet. When the incoming data packet complies with the first rule 122 but does not comply with the third rule 124, indicating that the VoIP data packet is directed to an authorized user of the internal network 30, the first bridging module 113 bridges the incoming data packet to the second connection port 152 to permit direct receipt thereof by a specific personal computer 32 in the internal network 30 through the hub 31. On the other hand, if the incoming data packet does not comply with the first rule 122 (that is, the incoming data packet is not a VoIP packet), the first bridging module 113 bridges the incoming data packet to the third connection port 153 to permit reception thereof by the firewall 40 for security control. Then, the secured incoming data packet is sent by the firewall 40 to the fourth connection port 154 for subsequent bridging to the second connection port 152 so that the specified personal computer 32 in the internal network 30 can receive the secured incoming data packet through the hub 31.

It should be pointed out herein that for convenience of illustration, the first and second rules 122, 123 are set up to indicate the code of the same connection port dedicated to VoIP services, and the third and fourth rules 124, 125 are set up as the same set of IP addresses of unauthorized users of the internal network 30. In actual practice, the first and second rules 122, 123, and the third and fourth rules 124, 125 can be set up to be identical in part or entirely different from each other. That is, for opposing flow directions from the external network 20 to the internal network 30 and from the internal network 30 to the external network 20, the gateway 10 allows the same application program to have different processing conditions for handling various sorts of data packets.

As evident from the foregoing, the configuration of the gateway 10 of this invention only requires several simple line connections and does not involve any alteration of the configurations of the existing firewalls or network system infrastructure, thereby reducing incurred costs since the burden of network administration personnel and equipment upgrading are alleviated. At the same time, the original security control function of the firewall, such as NAT, is retained. Furthermore, the assignment of specific ports and transmission paths for specific network applications can escalate switching speed for the entire network system.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A gateway for use in a network monitoring system that includes a firewall having internal and external connection ports, said gateway being adapted to be connected to external and internal networks and being adapted to control packet flow to the firewall, said gateway comprising:
a first connection port adapted to be connected to the external network;
a second connection port adapted to be connected to the internal network;
a third connection port adapted to be connected to the external connection port of the firewall;
a fourth connection port adapted to be connected to the internal connection port of the firewall;
a data storage device for storing a rules database therein, said rules database including a first rule associated with incoming data packets transmitted from the external network and to be directed to the internal network; and
a processing unit coupled to said first, second, third and fourth connection ports and said data storage device, said processing unit including
a first filter module for determining whether an incoming data packet received from the external network at said first connection port complies with the first rule, and
a first bridging module for bridging the incoming data packet to said second connection port to permit direct reception thereof by the internal network upon determination by said first filter module that the incoming data packet complies with the first rule, and for bridging the incoming data packet to said third connection port to permit reception thereof by the firewall upon determination by said first filter module that the incoming data packet does not comply with the first rule.

2. The gateway as claimed in claim 1, wherein said rules database further includes a second rule associated with outgoing data packets transmitted from the internal network and to be directed to the external network, said processing unit further including
a second filter module for determining whether an outgoing data packet received from the internal network at said second connection port complies with the second rule, and
a second bridging module for bridging the outgoing data packet to said first connection port to permit direct reception thereof by the external network upon determination by said second filter module that the outgoing data packet complies with the second rule, and for bridging the outgoing data packet to said fourth connection port to permit reception thereof by the firewall upon determination by said second filter module that the outgoing data packet does not comply with the second rule.

3. The gateway as claimed in claim 2, wherein each of the first and second rules indicates code of a connection port dedicated to VoIP services.

4. The gateway as claimed in claim 3, wherein each of the first and second rules indicates the code of the same connection port dedicated to VoIP services.

5. The gateway as claimed in claim 1, wherein the first rule indicates code of a connection port dedicated to VoIP services.

6. The gateway as claimed in claim 2, wherein said rules database further includes a third rule associated with the incoming data packets, said first filter module further determining whether the incoming data packet complies with the third rule, said first bridging module blocking further flow of the incoming data packet upon determination by said first filter module that the incoming data packet complies with both the first and third rules.

7. The gateway as claimed in claim 6, wherein said rules database further includes a fourth rule associated with the outgoing data packets, said second filter module further determining whether the outgoing data packet complies with the fourth rule, said second bridging module blocking further flow of the outgoing data packet upon determination by said second filter module that the outgoing data packet complies with both the second and fourth rules.

8. A network monitoring system adapted to be connected to external and internal networks, said network monitoring system comprising:
a firewall having internal and external connection ports; and
a gateway for controlling packet flow to said firewall, said gateway including
a first connection port adapted to be connected to the external network,
a second connection port adapted to be connected to the internal network,
a third connection port connected to said external connection port of said firewall,
a fourth connection port connected to said internal connection port of said firewall,
a data storage device for storing a rules database therein, said rules database including a first rule associated with incoming data packets transmitted from the external network and to be directed to the internal network, and
a processing unit coupled to said first, second, third and fourth connection ports and said data storage device, said processing unit including
a first filter module for determining whether an incoming data packet received from the external network at said first connection port complies with the first rule, and
a first bridging module for bridging the incoming data packet to said second connection port to permit direct reception thereof by the internal network upon determination by said first filter module that the incoming data packet complies with the first rule, and for bridging the incoming data packet to said third connection port to permit reception thereof by said firewall upon determination by said first filter module that the incoming data packet does not comply with the first rule.

9. The network monitoring system as claimed in claim 8, wherein said rules database further includes a second rule associated with outgoing data packets transmitted from the internal network and to be directed to the external network, said processing unit further including
a second filter module for determining whether an outgoing data packet received from the internal network at said second connection port complies with the second rule, and
a second bridging module for bridging the outgoing data packet to said first connection port to permit direct reception thereof by the external network upon determination by said second filter module that the outgoing data packet complies with the second rule, and for bridging the outgoing data packet to said fourth connection port to permit reception thereof by said firewall upon determination by said second filter module that the outgoing data packet does not comply with the second rule.

10. The network monitoring system as claimed in claim 9, wherein each of the first and second rules indicates code of a connection port dedicated to VoIP services.

11. The network monitoring system as claimed in claim 10, wherein each of the first and second rules indicates the code of the same connection port dedicated to VoIP services.

12. The network monitoring system as claimed in claim 8, wherein the first rule indicates code of a connection port dedicated to VoIP services.

13. The network monitoring system as claimed in claim 9, wherein said rules database further includes a third rule associated with the incoming data packets, said first filter module further determining whether the incoming data packet complies with the third rule, said first bridging module blocking further flow of the incoming data packet upon determination by said first filter module that the incoming data packet complies with both the first and third rules.

14. The network monitoring system as claimed in claim 13, wherein said rules database further includes a fourth rule associated with the outgoing data packets, said second filter module further determining whether the outgoing data packet complies with the fourth rule, said second bridging module blocking further flow of the outgoing data packet upon determination by said second filter module that the outgoing data packet complies with both the second and fourth rules.
